(19) United States
(12) Patent Application Publication
(10) Pub. No.: US 2019/0157971 A1
(43) Pub. Date: May 23, 2019

(54) POWER SUPPLY CIRCUIT

(71) Applicant: SHARP KABUSHIKI KAISHA, Sakai C ity (JP)

(72) Inventors: KOICHIRO FUJITA, Sakai City (JP); KENICHI TANAKA, Sakai City (JP); TOMOTOSHI SATOH, Sakai City (JP)

(21) Appl. No.: 16/189,262

(22) Filed: Nov. 13, 2018

(30) Foreign Application Priority Data
Nov. 17, 2017 (JP) 2017-221974

(51) Int. Cl. H02M 1/38; H02M 3/158

(52) U.S. Cl. CPC H02M 1/38; H02M 3/158

(57) ABSTRACT

A power supply circuit includes a first switch that is a FET composed of a GaN-based semiconductor material and a second switch that is another FET composed of a GaN-based semiconductor material. The drain of the first switch is connected to an input voltage side, the source of the first switch is connected to the drain of the second switch and an output voltage side. An false-turn-on suppression circuit that hinders, when one of the first switch and the second switch is switched on, the other of the first switch and the second switch from being switched on is connected to the gate of the first switch and/or the gate of the second switch.

### BACKGROUND

### 1. Field

The present disclosure relates to a power supply circuit.

### 2. Description of the Related Art

Conventionally, as a power supply circuit that converts a voltage of a DC power supply, a DC-DC converter in which a high side switch and a low side switch are switched on and off has been used (see, for example, Japanese Unexamined Patent Application Publication No. 2009-022106). In such a power supply circuit, power metal-oxide-semiconductor field-effect transistors (MOSFETs) made by using a Si-based material have typically been used as the high side switch and the low side switch. In recent years, however, a field-effect transistor (FET) made by using a GaN-based semiconductor material has been developed and is expected to be applied to a power device due to its advantages of lower on-resistance, higher frequency operation, higher temperature operation, and higher withstand voltage compared with Si-based materials.

FIG. 12 illustrates a conventional power supply circuit in which FETs composed of a GaN-based semiconductor material are used as a high side switch and a low side switch. In the power supply circuit illustrated in FIG. 12, the drain of a high side switch HiGaN composed of a GaN-based semiconductor material is connected to an input voltage Vin, and its source is connected to the drain of a low side switch LoGaN as an intermediate voltage Vsw and also to an output voltage Vout side. In addition, an inductor is interposed between the intermediate voltage Vsw and the output voltage Vout, and a capacitor is interposed between the output voltage Vout and a ground voltage. A gate voltage Vg_Hi is input to the high side switch HiGaN, and a gate voltage Vg_Lo is input to the low side switch LoGaN. This power supply circuit constitutes a buck DC-DC converter in which, for example, an input current Iin of 2 A at the input voltage Vin of 400 V is converted to an output current lout of 4 A at the output voltage Vout of 200 V.

FIGS. 13A and 13B are graphs illustrating normal operation of the conventional power supply circuit illustrated in FIG. 12. FIG. 13A is a graph illustrating changes in the gate voltage Vg_Lo of the low side switch LoGaN and changes in the intermediate voltage Vsw, and FIG. 13B is a graph illustrating changes in the input current Iin and changes in an inductor current I_ind.

As illustrated in FIG. 13A, after the gate voltage Vg_Lo of the low side switch LoGaN is changed from the ON state to the OFF state, the gate voltage Vg_Hi of the high side switch HiGaN is changed from the OFF state to the ON state (not shown) and the intermediate voltage Vsw increases. After the gate voltage Vg_Hi is changed from the ON state to the OFF state (not shown) and the intermediate voltage Vsw decreases, the gate voltage Vg_Lo is changed from the OFF state to the ON state.

During this period, as illustrated in FIG. 13B, the input current Iin monotonically increases from the timing when the gate voltage Vg_Hi is changed to the ON state to the timing when the gate voltage Vg_Hi is changed to the OFF state and subsequently decreases rapidly. Meanwhile, the inductor current I_ind monotonically increases from the timing when the gate voltage Vg_Hi is changed to the ON state to the timing when the gate voltage Vg_Hi is changed to the OFF state and subsequently decreases monotonically. The inductor current I_ind is smoothed by the capacitor and output in accordance with the output voltage Vout.

FIGS. 14A and 14B illustrate partially enlarged portions of the graph in FIG. 13A. FIG. 14A is a graph illustrating an enlarged portion corresponding to the timing when the gate voltage Vg_Hi is changed from the OFF state to the ON state. FIG. 14B is a graph illustrating an enlarged portion corresponding to the timing when the gate voltage Vg_Hi is changed from the ON state to the OFF state. As illustrated in FIGS. 14A and 14B, ringing occurs in the gate voltage Vg_Lo of the low side switch LoGaN at both the timing when the high side switch HiGaN is switched on and the timing when the high side switch HiGaN is switched off. In the example illustrated in FIGS. 14A and 14B, the voltage change is relatively small even though ringing occurs in the gate voltage Vg_Lo, and therefore the low side switch LoGaN is not switched on by accident, and the power supply circuit operates normally.

However, because the high side switch HiGaN and the low side switch LoGaN composed of a GaN-based semiconductor material are capable of high speed operation, there is a problem in which ringing caused by noise affecting one switch when the other switch is switched on during the high speed operation is of a relatively large degree, and as a result, a false turn ON, in which the one switch is switched on by accident, occurs.

FIGS. 15A and 15B are graphs illustrating changes in the gate voltage Vg_Lo of the low side switch LoGaN and changes in the intermediate voltage Vsw when the high side switch HiGaN is switched on in the conventional power supply circuit. FIG. 15A illustrates a case where ringing is of a relatively large degree, and FIG. 15B illustrates a case where ringing is of a relatively small degree. As illustrated in FIG. 15A, in the case where ringing in the gate voltage Vg_Lo is of a relatively large degree, the gate voltage Vg_Lo is excessively high in the area circled by a dashed line in the graph, and therefore a false turn ON occurs at the low side switch LoGaN. By contrast, as illustrated in FIG. 15B, in the case where ringing in the gate voltage Vg_Lo is of a relatively small degree, a false turn ON does not occur at the low side switch LoGaN. It is noted that the aforementioned ringing includes a single noise and a noise component that oscillates at a high frequency.

FIGS. 16A and 16B are photographs, as substitutes for drawings, illustrating temperature distribution of the power supply circuit illustrated in FIG. 12. FIG. 16A illustrates a case where a false turn ON occurs at the low side switch Lo_GaN, and FIG. 16B illustrates a case where a false turn ON does not occur at the low side switch Lo_GaN. In FIG. 16A, the high side switch Hi_GaN and the low side switch Lo_GaN are each indicated by a white arrow. The temperature in the area around the high side switch Hi_GaN is 34.6° C., the temperature in the area around the low side switch Lo_GaN is 34.1° C., and the power conversion efficiency is 83.70%. Likewise, in FIG. 16B, the high side switch Hi_GaN and the low side switch Lo_GaN are each indicated by a white arrow. The temperature in the area around the high side switch Hi_GaN is 35.3° C., the temperature in the area around the low side switch Lo_GaN is 31.5° C., and the power conversion efficiency is 87.14%.

As illustrated in FIGS. 16A and 16B, in the case where a false turn ON occurs at the low side switch Lo_GaN, since current flows from the intermediate voltage Vsw side to the ground voltage side, the power conversion efficiency decreases, and heat generated by power loss increases the temperature. Power conversion efficiency is a highly noteworthy index for a power device. The problem of a decrease in power conversion efficiency and an increase in temperature due to a false turn ON during high-speed driving is noticeable in a power supply circuit utilizing a FET made by using a GaN-based semiconductor material as a switch.

FIGS. 17A to 17C illustrate graphs indicating the state where the conventional power supply circuit is continuously driven. FIG. 17A is a graph illustrating changes in voltages over a long period during which a switching period is repeated multiple times, FIG. 17B illustrates an enlarged part of the graph that shows the state where a false turn ON occurs, and FIG. 17C illustrates an enlarged part of the graph that shows the state where a false turn ON does not occur, that is, a normal state.

As illustrated in FIGS. 17A to 17C, even in a power supply circuit using a FET of a GaN-based semiconductor material, a false turn ON caused by ringing, indicated by dashed-line circles in the graphs, occurs not every time, but randomly. If a false turn ON occurs often, the amount of heat generation increases. This leads to a concern that a large current may flow and elements may be damaged in some cases.

The present disclosure has been made to address these issues and provides a power supply device capable of hindering the occurrence of a false turn ON, which means that a switch is switched on by accident, even in a case where a GaN-based semiconductor material is utilized for the switch.

### SUMMARY

To address the above-described problems, a power supply circuit of the present disclosure includes a first switch that is a FET composed of a GaN-based semiconductor material and a second switch that is another FET also composed of a GaN-based semiconductor material. The drain of the first switch is connected to an input voltage side, the source of the first switch is connected to the drain of the second switch and an output voltage side. A false-turn-on suppression circuit that hinders, when one of the first switch and the second switch is switched on, the other of the first switch and the second switch from being switched on is connected to the gate of the first switch and/or the gate of the second switch.

With this configuration, the false-turn-on suppression circuit that is connected to the gate of the first switch and/or the gate of the second switch hinders the occurrence of ringing at one of the first switch and the second switch when the other is switched on, so that the occurrence of a false turn ON, which means that a switch is switched on by accident, can be hindered in a case where a GaN-based semiconductor material is used for the switches.

### BRIEF DESCRIPTION OF THE DRAWINGS

FIG. 1 is a circuit diagram illustrating a configuration of a power supply circuit according to an embodiment of the present disclosure;

FIG. 2A is a graph illustrating changes in a gate voltage Vg_Lo of a switch UL1 and changes in an intermediate voltage Vsw when a switch UH1 of a first embodiment is switched on in a case where the resistance value of a resistor RgH1 is 15Ω;

FIG. 2B is a graph illustrating changes in the gate voltage Vg_Lo of the switch UL1 and changes in the intermediate voltage Vsw when the switch UH1 of the first embodiment is switched on in a case where the resistance value of the resistor RgH1 is 76Ω;

FIG. 3A is a graph illustrating the relationship between the resistance value of the resistor RgH1 and the transition time of the intermediate voltage Vsw;

FIG. 3B is a graph illustrating the relationship between the transition time of the intermediate voltage Vsw and a false turn ON voltage;

FIG. 4A is a graph illustrating changes in the gate voltage Vg_Lo of the switch UL1 and changes in the intermediate voltage Vsw when the switch UH1 is switched on in a second embodiment in a case where the resistance value of the resistor RL1 is 3.3 kΩ, an input voltage Vin is 84 V, and an output voltage Vout is 12 V;

FIG. 4B is a graph illustrating changes in the gate voltage Vg_Lo of the switch UL1 and changes in the intermediate voltage Vsw when the switch UH1 is switched on in the second embodiment in a case where the resistance value of the resistor RL1 is 3.3 kΩ, the input voltage Vin is 116 V, and the output voltage Vout is 16 V;

FIG. 5A is a graph illustrating changes in the gate voltage Vg_Lo of the switch UL1 and changes in the intermediate voltage Vsw when the switch UH1 is switched on in the second embodiment in a case where the resistance value of the resistor RL1 is 1.0 kΩ, the input voltage Vin is 100 V, and the output voltage Vout is 14 V;

FIG. 5B is a graph illustrating changes in the gate voltage Vg_Lo of the switch UL1 and changes in the intermediate voltage Vsw when the switch UH1 is switched on in the second embodiment in a case where the resistance value of the resistor RL1 is 1.0 kΩ, the input voltage Vin is 150 V, and the output voltage Vout is 20 V;

FIG. 6A is a graph illustrating changes in the gate voltage Vg_Lo of the switch UL1 and changes in the intermediate voltage Vsw when the switch UH1 is switched off in a third embodiment in a case where a capacitor CL1 is not utilized;

FIG. 6B is a graph illustrating changes in the gate voltage Vg_Lo of the switch UL1 and changes in the intermediate voltage Vsw when the switch UH1 is switched off in the third embodiment in a case where the capacitor CL1 is utilized;

FIG. 7A is a graph illustrating changes in the gate voltage Vg_Lo of the switch UL1 and changes in the intermediate voltage Vsw when the switch UH1 is switched off in a fourth embodiment in a case where the resistance value of a resistor RgH2 is 2.2Ω;

FIG. 7B is a graph illustrating changes in the gate voltage Vg_Lo of the switch UL1 and changes in the intermediate voltage Vsw when the switch UH1 is switched off in the fourth embodiment in a case where the resistance value of the resistor RgH2 is 15Ω;

FIG. 7C is a graph illustrating changes in the gate voltage Vg_Lo of the switch UL1 and changes in the intermediate voltage Vsw when the switch UH1 is switched off in the fourth embodiment in a case where the resistor RgH2 is 48Ω;

FIG. 8 is a graph illustrating the relationships for respective set resistance values of the resistor RgH2 between the capacitance value of the capacitor CL1 under the standard according to the gate capacitance of the switch UL1 on the low side and the input voltage at which a false turn ON occurs;

FIG. 9 is a graph illustrating the relationship between the output power and the power conversion efficiency in an example of a false-turn-on suppression circuit;

FIG. 10 is a graph illustrating results of measuring the surface temperature of the switch UH1 and that of the switch UL1 in the example of the false-turn-on suppression circuit illustrated in FIG. 9;

FIG. 11 is a circuit diagram illustrating a configuration of a modified example of the power supply circuit of the present disclosure;

FIG. 12 illustrates a conventional power supply circuit in which FETs composed of a GaN-based semiconductor material are used as a high side switch and a low side switch;

FIG. 13A is a graph illustrating changes in a gate voltage Vg_Lo of a low side switch LoGaN and changes in an intermediate voltage Vsw during a normal operation of the conventional power supply circuit illustrated in FIG. 12;

FIG. 13B illustrates changes in an input current Iin and changes in an inductor current I_ind during a normal operation of the conventional power supply circuit illustrated in FIG. 12;

FIG. 14A is a partially enlarged portion of the graph in FIG. 13A corresponding to the timing when a gate voltage Vg_Hi is changed from the OFF state to the ON state.

FIG. 14B is a partially enlarged portion of the graph in FIG. 13A corresponding to the timing when the gate voltage Vg_Hi is changed from the ON state to the OFF state;

FIG. 15A is a graph illustrating changes in the gate voltage Vg_Lo of the low side switch LoGaN and changes in the intermediate voltage Vsw when the high side switch HiGaN is switched on in the conventional power supply circuit in a case where ringing is of a relatively large degree;

FIG. 15B is a graph illustrating changes in the gate voltage Vg_Lo of the low side switch LoGaN and changes in the intermediate voltage Vsw when the high side switch HiGaN is switched on in the conventional power supply circuit in a case where ringing is of a relatively small degree;

FIG. 16A is a photograph, as a substitute for a drawing, illustrating temperature distribution of the power supply circuit illustrated in FIG. 12 in a case where a false turn ON occurs at the low side switch Lo_GaN;

FIG. 16B is a photograph, as a substitute for a drawing, illustrating temperature distribution of the power supply circuit illustrated in FIG. 12 in a case where a false turn ON does not occur at the low side switch Lo_GaN; and

FIGS. 17A to 17C illustrate graphs indicating the state where the conventional power supply circuit is continuously driven, where FIG. 17A is a graph illustrating changes in voltages in a long period during which a switching period is repeated multiple times, FIG. 17B illustrates an enlarged part of the graph that shows the state where a false turn ON occurs, and FIG. 17C illustrates an enlarged part of the graph that shows the state where a false turn ON does not occur, that is, a normal state.

### DESCRIPTION OF THE EMBODIMENTS

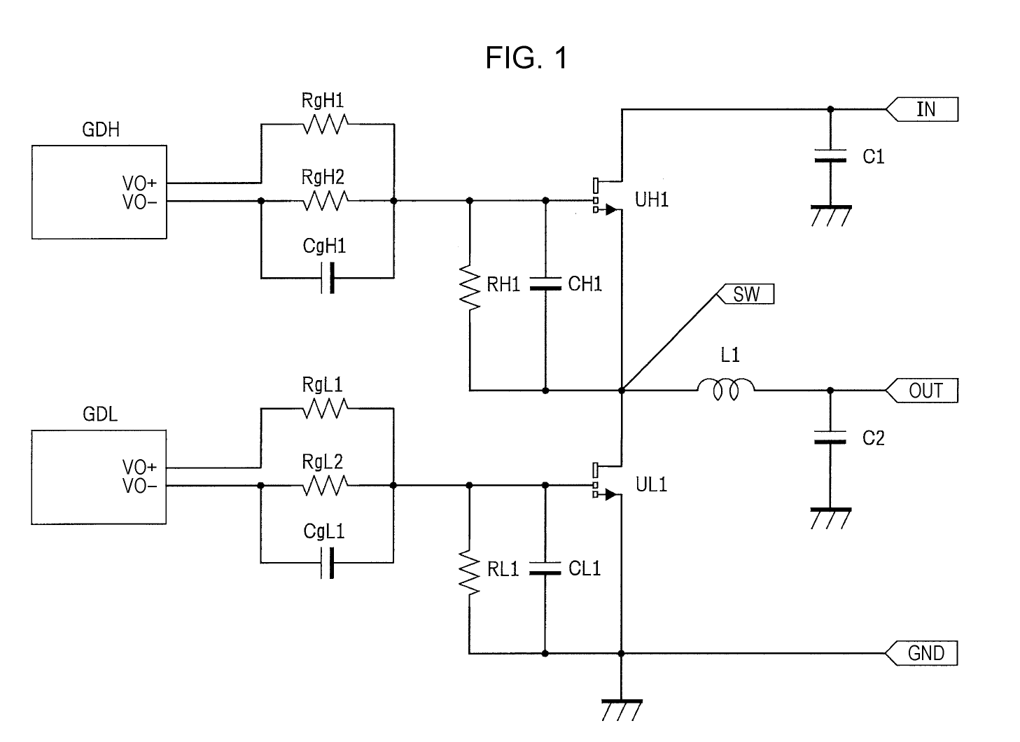

Embodiments of the present disclosure are described below with reference to the drawings. FIG. 1 is a circuit diagram illustrating a configuration of a power supply circuit according to an embodiment of the present disclosure. As illustrated in FIG. 1, the power supply circuit of this embodiment includes switches UH1 and UL1, an inductor L1, capacitors C1, C2, CH1, CL1, CgH1, and CgL1, resistors RH1, RL1, RgH1, RgH2, RgL1, and RgL2, gate drivers GDH and GDL, and terminals IN, OUT, SW, and GND.

The switches UH1 and UL1 are each a FET composed of a GaN-based semiconductor material. The switch UH1 is a high side switch and corresponds to a first switch of the present disclosure. The switch UL1 is a low side switch and corresponds to a second switch of the present disclosure.

The drain of the switch UH1 is connected to the terminal IN on the input voltage side, and the source of the switch UH1 is connected to the terminal SW as the intermediate voltage and the drain of the switch UL1. The capacitor C1 is connected to the ground voltage between the terminal IN and the switch UH1. The inductor L1 is connected between the terminal OUT as the output voltage and the terminal SW. The source of the switch UL1 is connected to the terminal GND as the ground voltage.

The gate driver GDH is a high side gate driver that outputs a voltage to the gate of the switch UH1, which is the GaNFET on the high side. The gate driver GDL is a low side gate driver that outputs a voltage to the gate of the switch UL1, which is the GaNFET on the low side. The gate drivers GDH and GDL each have a VO+ terminal for supplying a voltage for sourcing and a VO− terminal for supplying a voltage for sinking.

The resistor RgH1 is connected as a high side gate resistor between the VO+ terminal of the gate driver GDH and the gate of the switch UH1, and the resistor RgL1 is connected as a low side gate resistor between the VO+ terminal of the gate driver GDL and the gate of the switch UL1. Furthermore, the resistor RgH2 is connected as another high side gate resistor between the VO− terminal of the gate driver GDH and the gate of the switch UH1, and the resistor RgL2 is connected as another low side gate resistor between the VO− terminal of the gate driver GDL and the gate of the switch UL1. Moreover, the high side gate capacitor CgH1 is connected in parallel with the resistor RgH2, and the low side gate capacitor CgL1 is connected in parallel with the resistor RgL2.

The high side gate-source resistor RH1 and the high side gate-source capacitor CH1 are connected between the gate and the source of the switch UH1, and the low side gate-source resistor RL1 and the low side gate-source capacitor CL1 are connected between the gate and the source of the switch UL1.

As described above, in the power supply circuit of the present disclosure, an false-turn-on suppression circuit, which includes any of the resistors RgH1, RgH2, RgL1, RgL2, RH1, and RL1, and the capacitors CgH1, CgL1, CH1, and CL1, is connected to the gate of the switch UH1 corresponding to the first switch and the gate of the switch UL1 corresponding to the second switch. By connecting the false-turn-on suppression circuit to the gate of the switch UH1 and the gate of the UL1, the case where one switch is switched on in response to the other switch being switched on can be avoided.

### First Embodiment

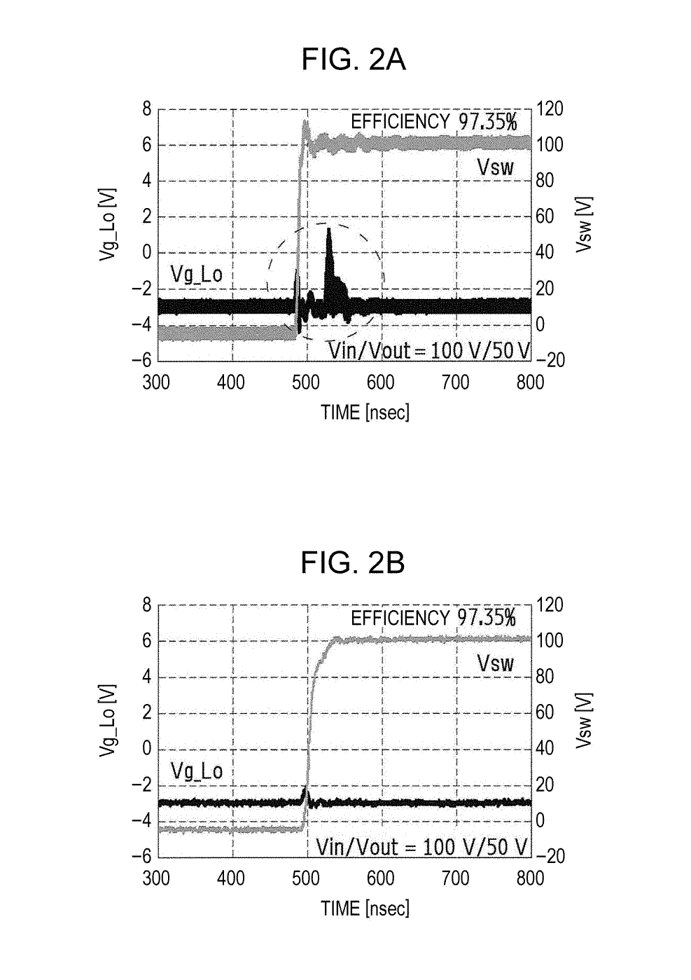

Next, as a first embodiment of the present disclosure, a case where the false-turn-on suppression circuit is constituted by the resistor RgH1 connected between the gate of the switch UH1 as the high side switch and the VO+ terminal of the gate driver GDH is described. FIGS. 2A and 2B are graphs illustrating changes in a gate voltage Vg_Lo of the switch UL1 and changes in an intermediate voltage Vsw when the switch UH1 of the first embodiment is switched on. FIG. 2A illustrates a case where the resistance value of the resistor RgH1 is 15Ω, and FIG. 2B illustrates a case where the resistance value of the resistor RgH1 is 76Ω. Both FIGS. 2A and 2B illustrate a case where the voltage that is supplied to the terminal IN on the input side is 100 V and the voltage that is output from the terminal OUT on the output side is 50 V.

As illustrated in FIG. 2A, in a case where the resistance value of the resistor RgH1 is as small as 15Ω, the switching speed of the switch UH1 as the high side switch is relatively high and the transition time of the intermediate voltage Vsw is 4.6 ns. In this case, a relatively large degree of ringing occurs in the gate voltage Vg_Lo of the switch UL1 as the low side switch and a false turn ON, which means that the switch UL1 is switched on by accident, occurs. By contrast, as illustrated in FIG. 2B, in a case where the resistance value of the resistor RgH1 is as large as 76Ω, the switching speed of the switch UH1 is relatively slow and the transition time of the intermediate voltage Vsw is 22.4 ns. In this case, ringing that occurs in the gate voltage Vg_Lo of the switch UL1 is of a relatively small degree and a false turn ON does not occur.

In both cases of FIGS. 2A and 2B, the power conversion efficiency is 97.35%, no decrease in efficiency due to the variations of the resistor RgH1 is observed, and the switching loss does not increase. In the case where the resistance value of the resistor RgH1 is 15Ω as illustrated in FIG. 2A, overshoot occurs when the intermediate voltage Vsw rises, but in the case where the resistance value of the resistor RgH1 is 76Ω as illustrated in FIG. 2B, the occurrence of overshoot is suppressed when the intermediate voltage Vsw rises.

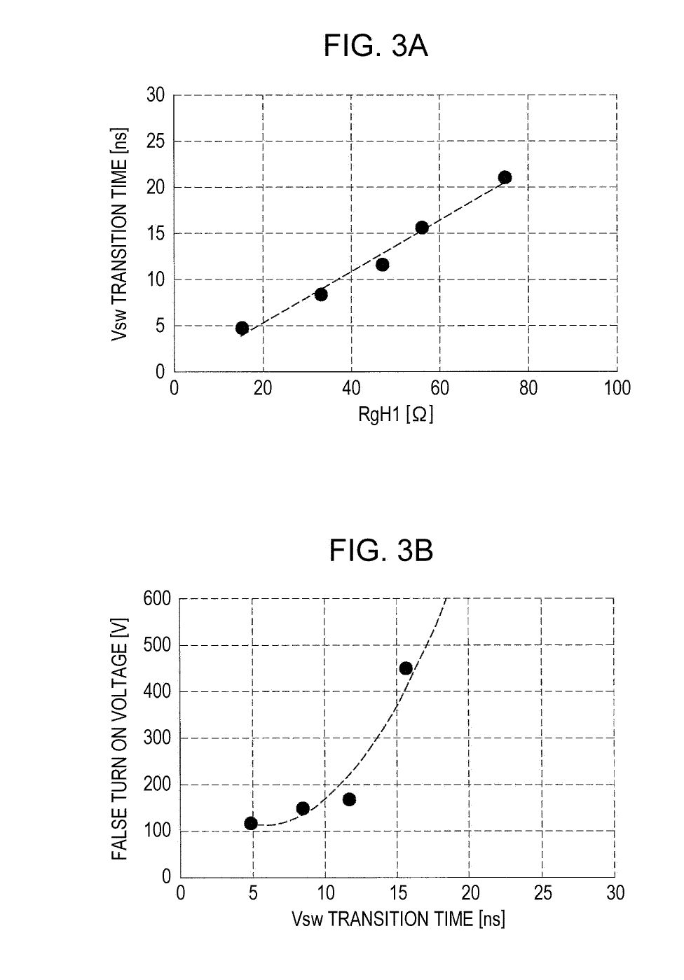

FIGS. 3A and 3B are graphs illustrating the relationships between the resistor RgH1, the intermediate voltage Vsw, and a false turn ON voltage. FIG. 3A illustrates the relationship between the resistance value of the resistor RgH1 and the transition time of the intermediate voltage Vsw, and FIG. 3B illustrates the relationship between the transition time of the intermediate voltage Vsw and the false turn ON voltage. The false turn ON voltage is the value of the input voltage Vin that is supplied to the terminal IN on the input side when a false turn ON occurs at the switch UL1 on the low side.

In FIG. 3A, the horizontal axis indicates the resistance value of the resistor RgH1, the vertical axis indicates the transition time of the intermediate voltage Vsw, black circles indicate measured values, and a dashed line indicates a trend line. As illustrated in FIG. 3A, the relationship between the resistance value of the resistor RgH1 and the transition time is expressed as a linear function, and when as the resistance value of the resistor RgH1 increases, the transition time of the intermediate voltage Vsw monotonically increases.

In FIG. 3B, the horizontal axis indicates the transition time of the intermediate voltage Vsw, the vertical axis indicates the voltage at which a false turn ON occurs at the switch UL1, black circles indicate measured values, and a dashed line indicates a trend line. As illustrated in FIG. 3B, as the transition time increases, the false turn ON voltage increases steeply.

As illustrated in FIG. 3B, as the transition time increases, the false turn ON voltage increases quadratically, and when the transition time is 12 ns or more, the false turn ON voltage is about 200 V or more. As illustrated in FIG. 3A, the case where the transition time is 12 ns corresponds to the case where the resistance value of the resistor RgH1 is 47Ω. Hence, by utilizing the resistor RgH1 whose resistance value is 47Ω or more, the false turn ON voltage can be much higher, such that a higher voltage can be supplied to the terminal IN on the input side.

As described above, in this embodiment, as the false-turn-on suppression circuit, the resistor RgH1 as the high side gate resistor is connected between the gate of the switch UH1 and the VO+ terminal of the gate driver GDH, thereby hindering, when the switch UH1 is switched on, the switch UL1 from being consequently switched on. In addition, by utilizing the resistor RgH1 whose resistance value is 47Ω or more, the false turn ON voltage can be higher, such that a higher voltage can be supplied to the terminal IN on the input side.

### Second Embodiment

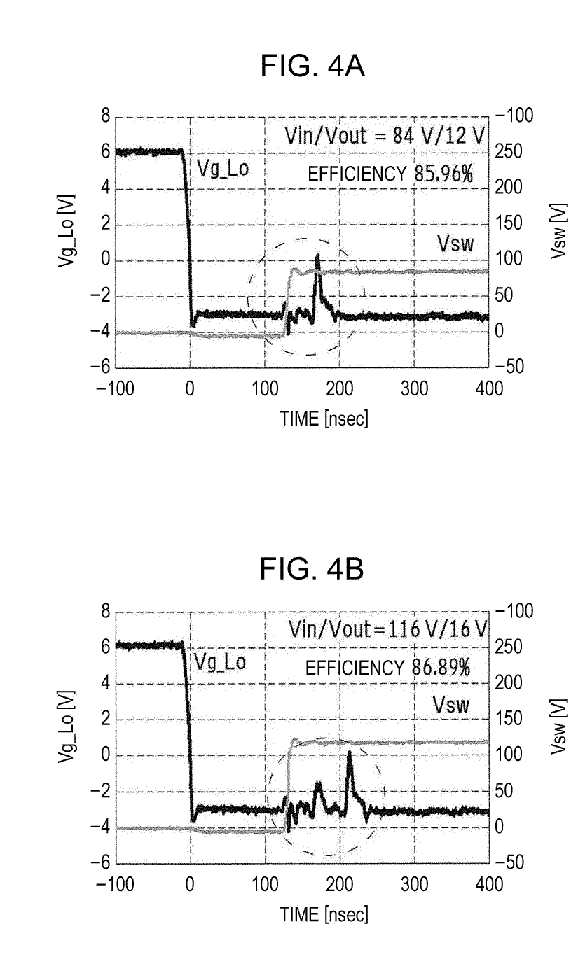

Next, as a second embodiment of the present disclosure, a case where the false-turn-on suppression circuit is constituted by the resistor RL1 that is connected between the gate and the source of the switch UL1 as the low side switch is described. FIGS. 4A and 4B are graphs illustrating changes in the gate voltage Vg_Lo of the switch UL1 and changes in the intermediate voltage Vsw when, in a case where the resistance value of the resistor RL1 is 3.3 kΩ, the switch UH1 is switched on in the second embodiment. FIG. 4A illustrates a case where the input voltage Vin is 84 V and the output voltage Vout is 12 V, and FIG. 4B illustrates a case where the input voltage Vin is 116 V and the output voltage Vout is 16 V. The power conversion efficiency is 85.96% in the case where Vin/Vout are 84 V/12 V, and 86.89% in the case where Vin/Vout are 116 V/16 V.

As illustrated in FIGS. 4A and 4B, in a case where the resistance value of the resistor RL1 is 3.3 kΩ, ringing occurs in the gate voltage Vg_Lo when the switch UH1 as the high side switch is switched on, and it can be regarded as the sign of a false turn ON. However, since the resistor RL1 is connected between the gate of the switch UL1 and the terminal GND, the gate voltage can be fixed with respect to the ground voltage, thereby suppressing the occurrence of a false turn ON.

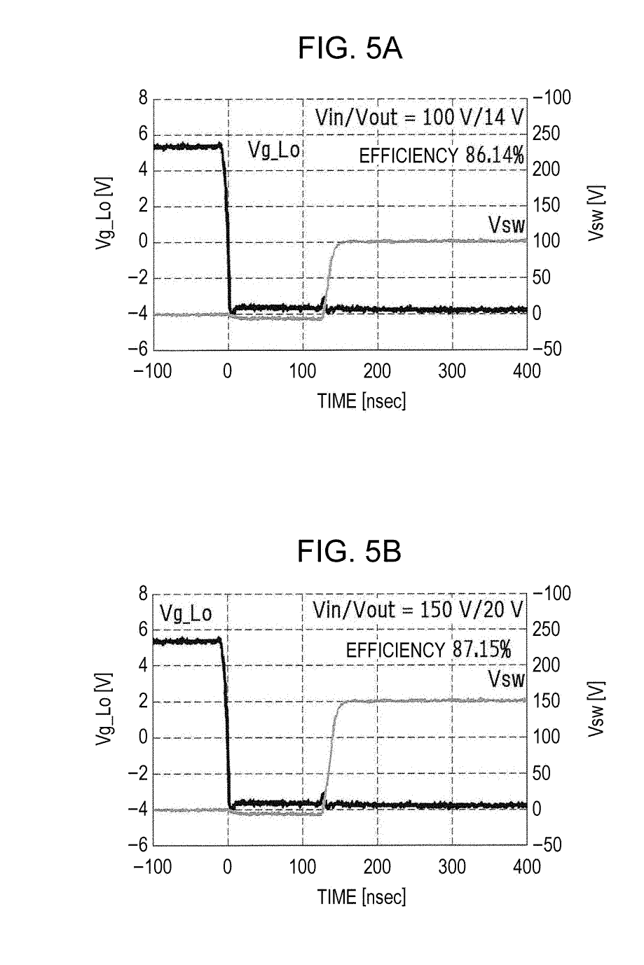

FIGS. 5A and 5B are graphs illustrating changes in the gate voltage Vg_Lo of the switch UL1 and changes in the intermediate voltage Vsw when, in a case where the resistance value of the resistor RL1 is 1.0 kΩ, the switch UH1 is switched on in the second embodiment. FIG. 5A illustrates a case where the input voltage Vin is 100 V and the output voltage Vout is 14 V, and FIG. 5B illustrates a case where the input voltage Vin is 150 V and the output voltage Vout is 20 V. The power conversion efficiency is 86.14% in the case where Vin/Vout are 100 V/14 V, and 87.15% in the case where Vin/Vout are 150 V/20 V.

As illustrated in FIGS. 5A and 5B, in the case where the resistance value of the resistor RL1 is 1.1 kΩ, ringing does not occur in the gate voltage Vg_Lo when the switch UH1 as the high side switch is switched on, and a false turn ON does not occur.

As illustrated in FIGS. 4A and 4B, and FIGS. 5A and 5B, since the resistor RL1 is connected between the gate and the source of the switch UL1, the gate voltage can be fixed with respect to the ground voltage, thereby suppressing the occurrence of a false turn ON. In addition, when the resistance value of the resistor RL1 is relatively small, an instant change of the voltage can be relatively small between the gate of the switch UL1 and the terminal GND, thereby hindering the occurrence of ringing in the gate voltage Vg_Lo. The resistance value of the resistor RL1 is preferably 5 kΩ or less, more preferably 3.5 kΩ or less, and further preferably 1.0 kΩ or less.

As described above, in this embodiment, as the false-turn-on suppression circuit, the resistor RL1 as the low side gate-source resistor is connected between the gate and source of the switch UL1, thereby hindering, when the switch UH1 is switched on, the switch UL1 from being consequently switched on. In addition, by utilizing the resistor RL1 whose resistance value is 5Ω or less, the occurrence of a false turn ON can be hindered.

### Third Embodiment

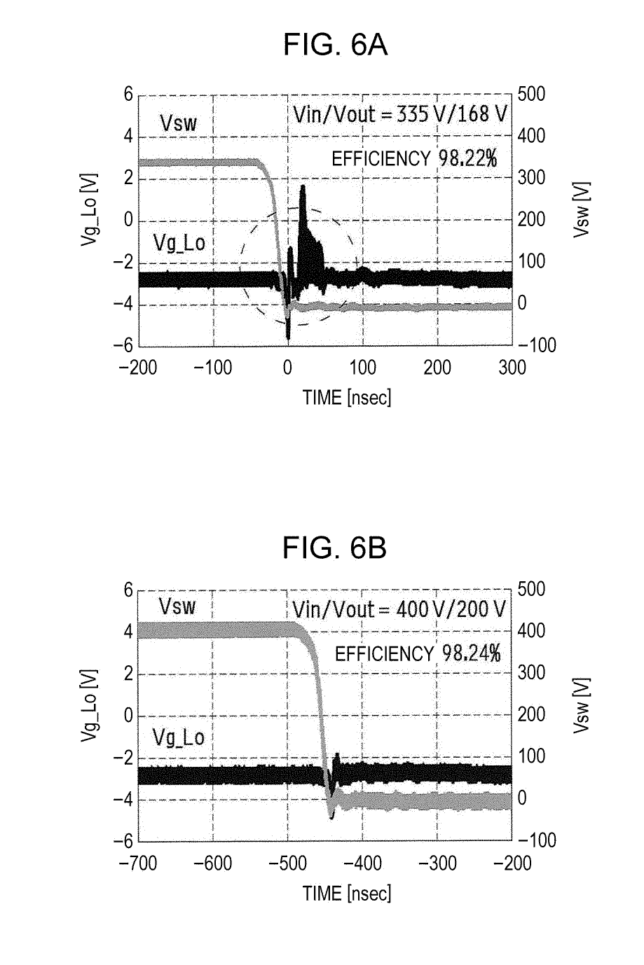

Next, as a third embodiment of the present disclosure, a case where the false-turn-on suppression circuit is constituted by the capacitor CL1 that is connected between the gate and the source of the switch UL1 as the low side switch is described. FIGS. 6A and 6B are graphs illustrating changes in the gate voltage Vg_Lo of the switch UL1 and changes in the intermediate voltage Vsw when the switch UH1 is switched off in the third embodiment. FIG. 6A illustrates a case where the capacitor CL1 is not utilized, and FIG. 6B illustrates a case where the capacitor CL1 is utilized. In FIG. 6B, the capacitor CL1 with the capacitance of 470 pF is utilized.

FIG. 6A illustrates a case where the input voltage Vin is 335 V and the output voltage Vout is 168 V, and FIG. 6B illustrates a case where the input voltage Vin is 400 V and the output voltage Vout is 200 V. The power conversion efficiency is 98.22% in the case where the capacitor CL1 is not utilized and Vin/Vout are 335 V/168 V, and 98.24% in the case where the capacitor CL1 is utilized and Vin/Vout are 400 V/200 V.

In the case where the capacitor CL1 is not utilized, as illustrated in FIG. 6A, even though the input voltage Vin is 335 V, a large degree of ringing occurs in the gate voltage Vg_Lo when the switch UH1 is switched off and a false turn ON occurs at the switch UL1. By contrast, in the case where the capacitor CL1 is utilized, although the input voltage Vin is 400 V, ringing that occurs in the gate voltage Vg_Lo is of a relatively small degree and a false turn ON does not occur at the switch UL1. This is because, by connecting the capacitor CL1 between the gate and the source of the switch UL1, noise caused in the gate voltage Vg_Lo during the period of several ns to several tens ns is routed to the ground voltage and released.

As described above, in this embodiment, as the false-turn-on suppression circuit, the capacitor CL1 as the low side gate-source capacitance is connected between the gate and the source of the switch UL1, thereby hindering, when the switch UH1 is switched off, the switch UL1 from being consequently switched on.

### Fourth Embodiment

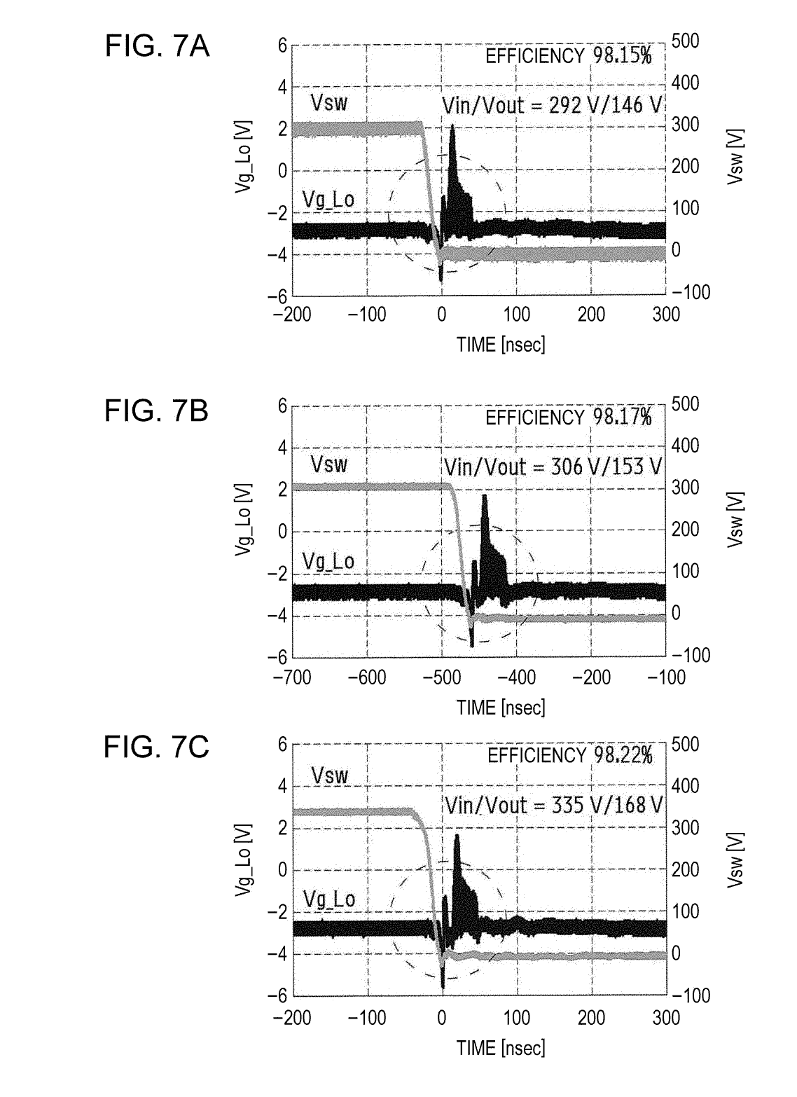

Next, as a fourth embodiment of the present disclosure, a case where the false-turn-on suppression circuit is constituted by the resistor RgH2 that is connected between the gate of the switch UH1 as the high side switch and the VO− terminal of the gate driver GDH is described. FIGS. 7A to 7C are graphs illustrating changes in the gate voltage Vg_Lo of the switch UL1 and changes in the intermediate voltage Vsw when the switch UH1 is switched off in the fourth embodiment. FIG. 7A illustrates a case where the resistance value of the resistor RgH2 is 2.2Ω, FIG. 7B illustrates a case where the resistance value of the resistor RgH2 is 15Ω, and FIG. 7C illustrates a case where the resistance value of the resistor RgH2 is 48Ω.

In the case where the resistance value of the resistor RgH2 is 2.2Ω as illustrated in FIG. 7A, when the input voltage Vin is 292 V and the output voltage Vout is 146 V, a large degree of ringing occurs in the gate voltage Vg_Lo and a false turn ON occurs. In this case, the power conversion efficiency is 98.15%. In the case where the resistance value of the resistor RgH2 is 15Ω as illustrated in FIG. 7B, when the input voltage Vin is 306 V and the output voltage Vout is 153 V, a large degree of ringing occurs in the gate voltage Vg_Lo and a false turn ON occurs. In this case, the power conversion efficiency is 98.17%. In the case where the resistance value of the resistor RgH2 is 48Ω as illustrated in FIG. 7C, when the input voltage Vin is 335 V and the output voltage Vout is 168 V, a large degree of ringing occurs in the gate voltage Vg_Lo and a false turn ON occurs. In this case, the power conversion efficiency is 98.22%.

As illustrated in FIGS. 7A to 7C, by increasing the resistance value of the resistor RgH2, the value of the input voltage Vin at which a false turn ON occurs increases. This is because, by slowing the switching speed at which the switch UH1 as the high side switch is switched off, noise is unlikely added to the gate voltage Vg_Lo of the switch UL1 as the low side switch. In this case, when the resistance value of the resistor RgH2 is about 47Ω, a false turn ON does not occur even if the input voltage Vin is about 300 V. The resistance value of the resistor RgH2 is therefore preferably 47Ω or more.

As described above, in this embodiment, as the false-turn-on suppression circuit, the resistor RgH2 as the low side gate-source resistor is connected between the gate and the source of the switch UL1, thereby hindering, when the switch UH1 is switched off, the switch UL1 from being consequently switched on. In addition, by utilizing the resistor RgH2 with the resistance value of 47Ω or more, the occurrence of a false turn ON can be hindered.

### Fifth Embodiment

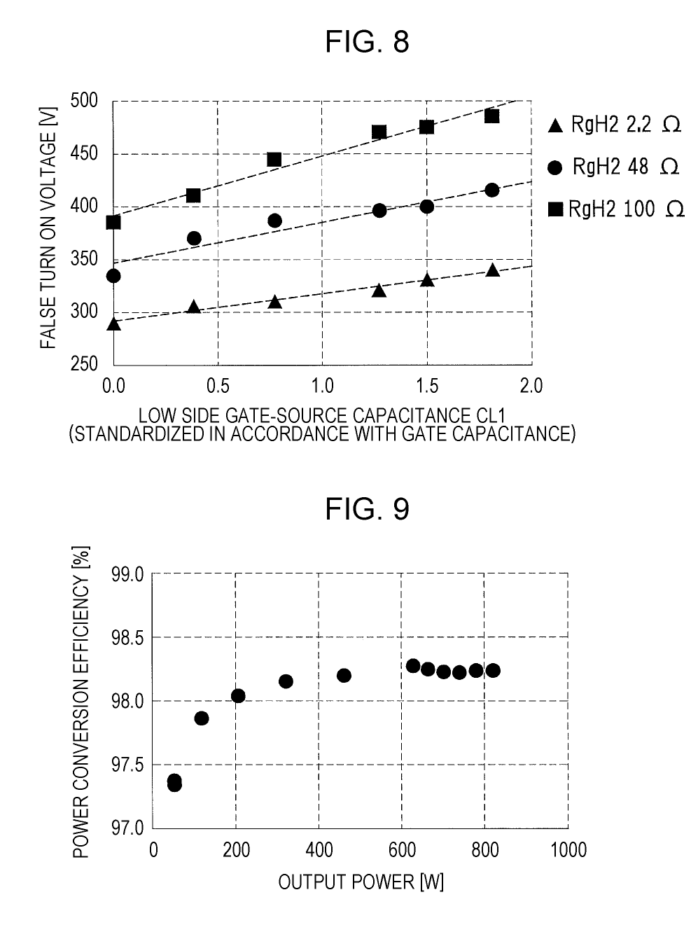

Next, as a fifth embodiment of the present disclosure, a case where the false-turn-on suppression circuit is constituted by both the capacitor CL1 that is connected between the gate and the source of the switch UL1 as the low side switch and the resistor RgH2 that is connected between the gate of the switch UH1 as the high side switch and the VO− terminal of the gate driver GDH is described. FIG. 8 is a graph illustrating the relationships for respective set resistance values of the resistor RgH2 between the capacitance value of the capacitor CL1 under the standard according to the gate capacitance of the switch UL1 on the low side and the input voltage at which a false turn ON occurs. In FIG. 8, ▴ indicates 2.2Ω, ● indicates 48Ω, and ▪ indicates 100Ω; and a dashed line indicates a trend line for each relationship.

As understood from FIG. 8, for each resistance value of the resistor RgH2, by setting the standardized value on the capacitor CL1 over the values of the trend line, the occurrence of a false turn ON can be hindered. As further understood from FIG. 8, the standardized value of the capacitor CL1 for hindering the occurrence of a false turn ON varies depending on the resistance value of the resistor RgH2.

As such, depending on other circuit constants such as the resistance value of the resistor RgH2 a different value is applied for the capacitor CL1 for hindering the occurrence of a false turn ON. Meanwhile, as the resistance value of the resistor RgH2 decreases, the switching speed increases and thus switching efficiency improves. Therefore, the value of the resistor RgH2 and the standardized value of the capacitor CL1 can be set to suitable values in the area on the right side of a trend line indicating a relationship illustrated in FIG. 8.

The present disclosure and the embodiments are concluded as follows. To provide a power supply device capable of hindering the occurrence of a false turn ON in a case where a GaN-based semiconductor material is utilized for a switch, the false-turn-on suppression circuit, which hinders, when one switch is switched on, the other switch from being consequently switched on, is connected in the power supply circuit of the present disclosure.

As an example of the false-turn-on suppression circuit, a power supply circuit in which a false turn ON does not occur even when the input voltage Vin is 400 V can be made, where the resistance value of the resistor RgH1, which is connected between the gate of the switch UH1 and the VO+ terminal of the gate driver GDH, is 76Ω, the resistance value of the resistor RL1, which is connected between the gate and the source of the switch UL1, is 1.0 kΩ, the capacitance value of the capacitor CL1, which is connected between the gate and the source of the switch UL1, is 470 pF, and the resistance value of the resistor RgH2, which is connected between the gate of the switch UH1 and the VO− terminal of the gate driver GDH, is 47Ω.

FIG. 9 is a graph illustrating the relationship between the output power and the power conversion efficiency in the above-described example of the false-turn-on suppression circuit. In a case where the false-turn-on suppression circuit is used as a buck converter in which the input voltage Vin is 400 V, the output voltage Vout is 200 V, output power Pout is 800 W, the power conversion efficiency is 98.24%.

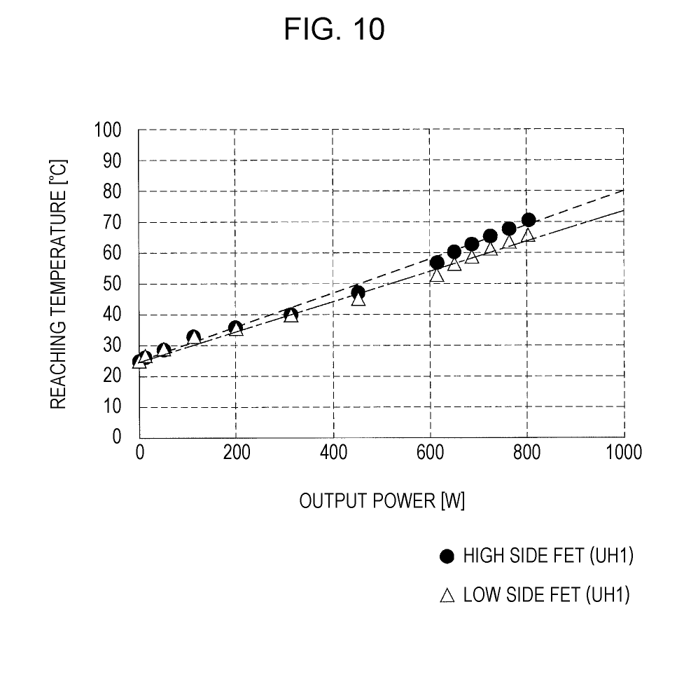

FIG. 10 is a graph illustrating results of measuring the surface temperature of the switch UH1 and that of the switch UL1 in the example of the false-turn-on suppression circuit illustrated in FIG. 9. The measurement of the surface temperature is carried out under the condition of natural cooling without a cooling fin. As illustrated in FIG. 10, in a case where the false-turn-on suppression circuit is used as a buck converter in which the input voltage Vin is 400 V, the output voltage Vout is 200 V, the output power Pout is 800 W, the temperature reaches up to 75° C. Hence, the false-turn-on suppression circuit of the present disclosure can achieve stable operation as a buck converter.

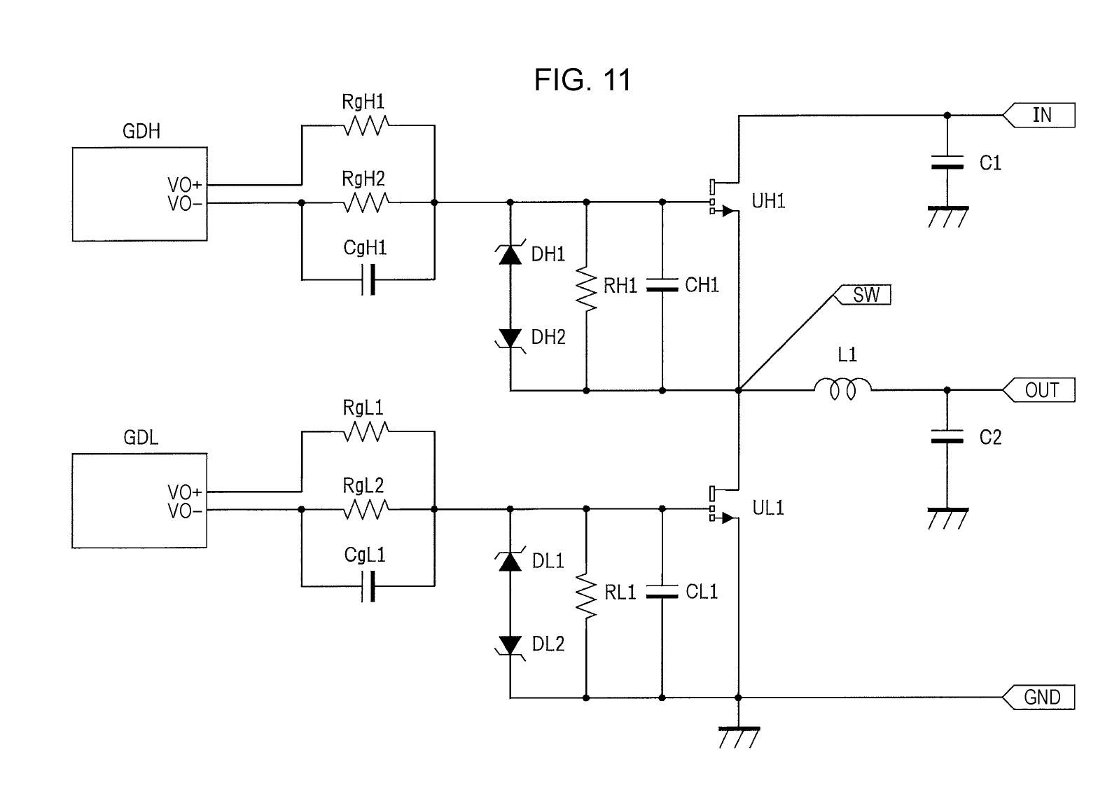

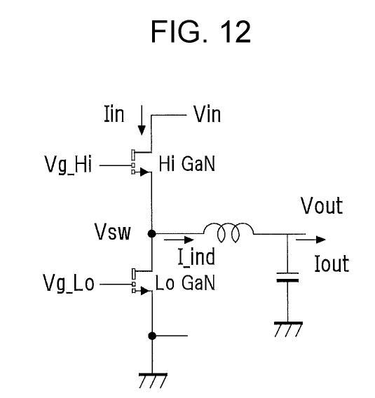

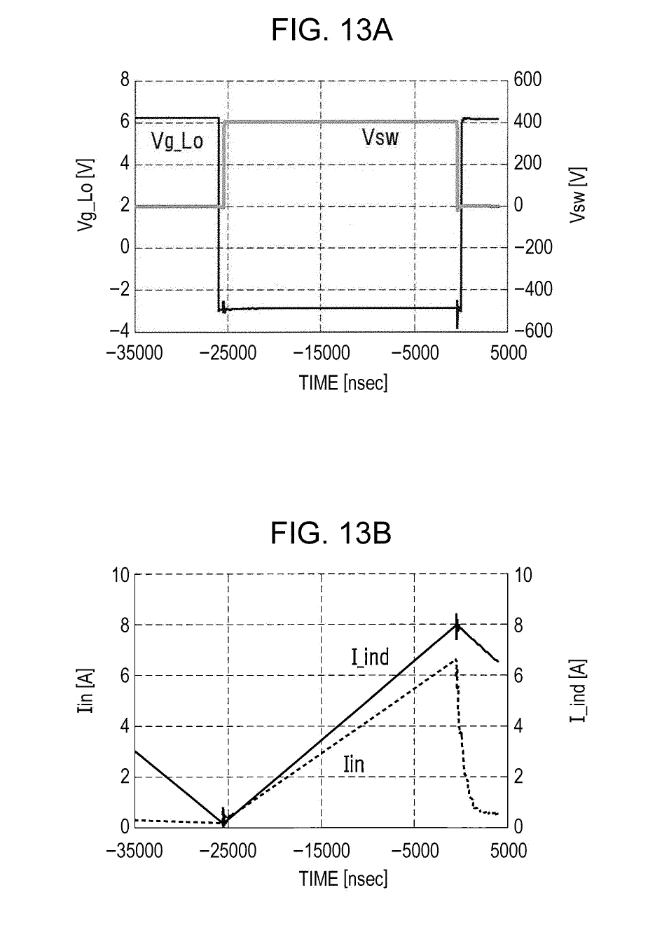

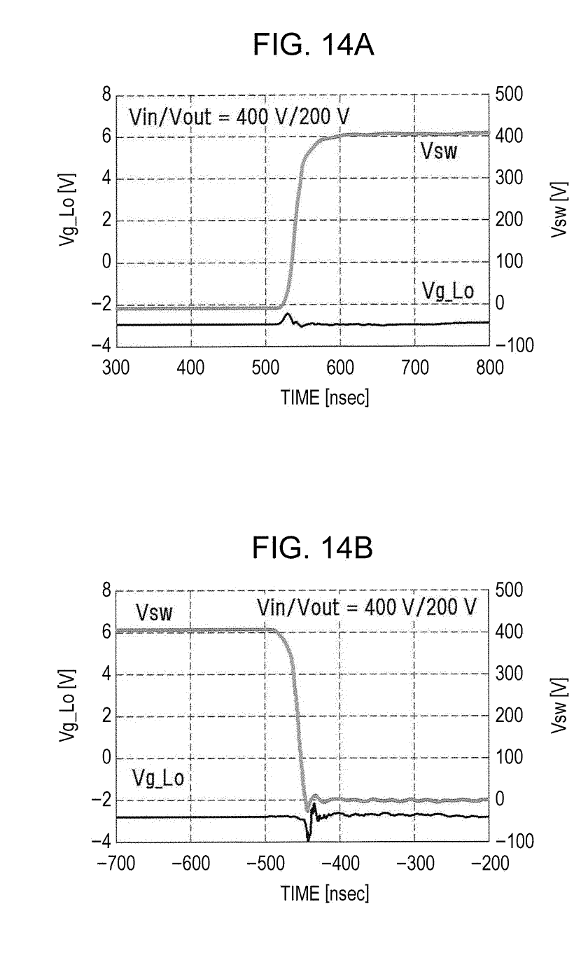

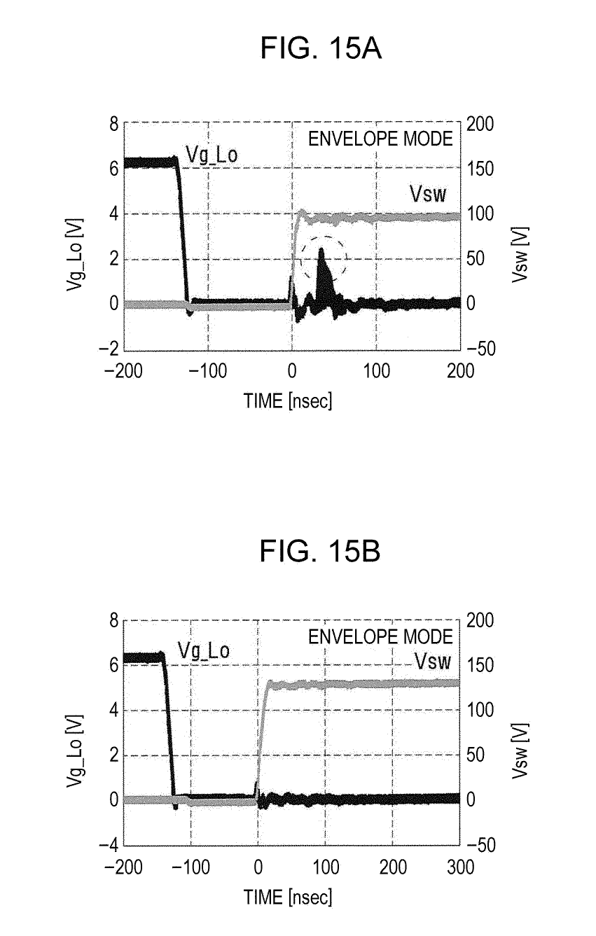

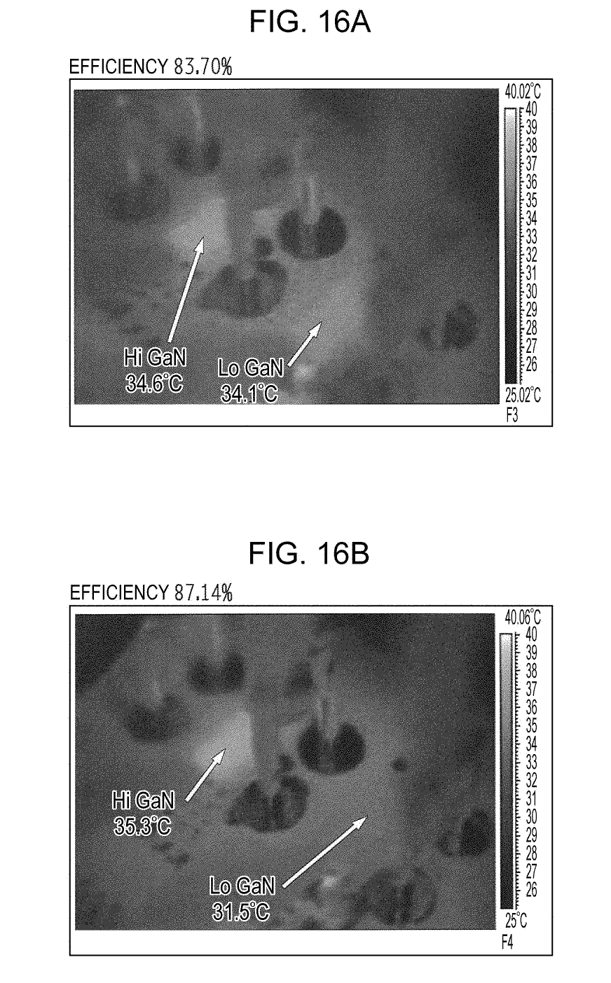

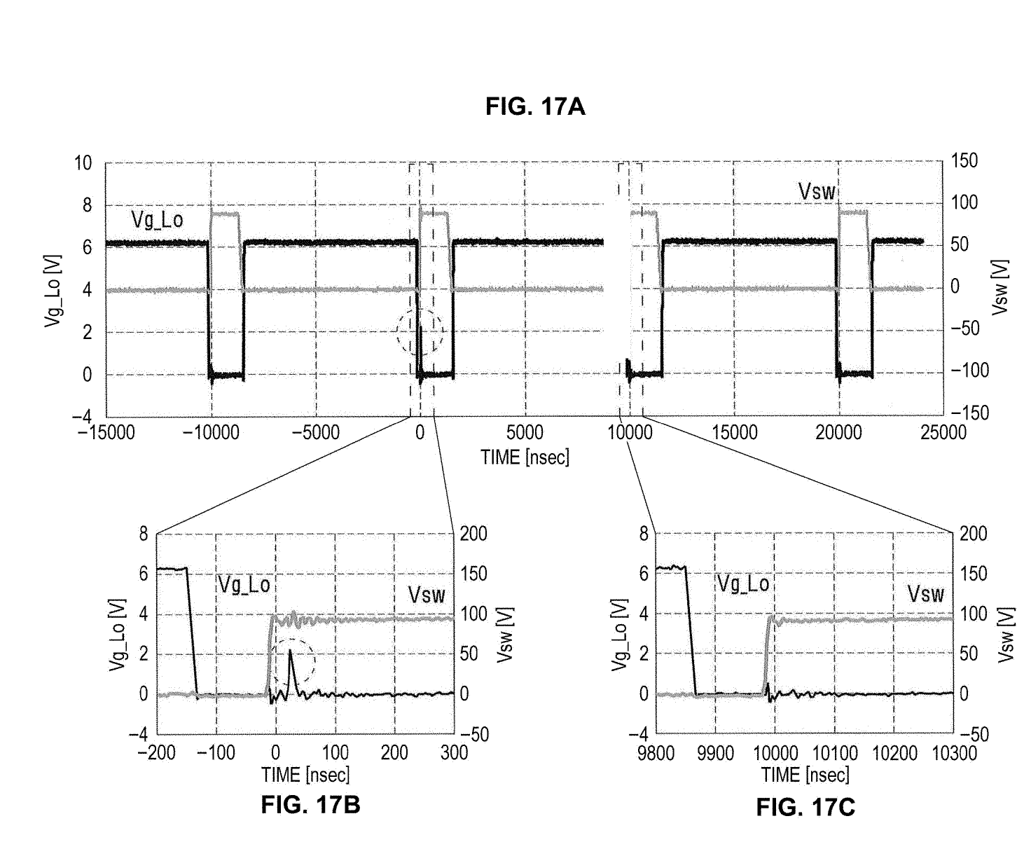

It is noted that the embodiments disclosed here are illustrative in all respects and not considered as the basis for restrictive interpretation. FIG. 11 is a circuit diagram illustrating a configuration of a modified example of the power supply circuit of the present disclosure. As illustrated in FIG. 11, in the present disclosure, for example, diodes DH1, DH2, DL1, and DL2 for hindering the application of excess voltage to the gate voltage may be disposed between the gate and the source of the switch UH1 and the gate and the source of the switch UL1. The scope of the present disclosure is indicated by the appended claims rather than by only the foregoing description. All variations and modifications falling within the meaning and range of equivalency of the claims are intended to be embraced in the scope of the present disclosure.

The present disclosure contains subject matter related to that disclosed in Japanese Priority Patent Application JP 2017-221974 filed in the Japan Patent Office on Nov. 17, 2017, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A power supply circuit comprising:
a first switch that is a FET composed of a GaN-based semiconductor material; and
a second switch that is another FET composed of a GaN-based semiconductor material, wherein
a drain of the first switch is connected to an input voltage side,
a source of the first switch is connected to a drain of the second switch and an output voltage side, and
a false-turn-on suppression circuit that hinders, when one of the first switch and the second switch is switched on, the other of the first switch and the second switch from being switched on and that is connected to a gate of the first switch and/or a gate of the second switch.

2. The power supply circuit according to claim 1, wherein the false-turn-on suppression circuit is constituted by a capacitor that is connected between the gate of the second switch and the source of the second switch.

3. The power supply circuit according to claim 1, wherein the false-turn-on suppression circuit is constituted by a first resistor that is connected between the gate of the second switch and the source of the second switch.

4. The power supply circuit according to claim 3, wherein a resistance value of the first resistor is 5 kΩ or less.

5. The power supply circuit according to claim 1, wherein the false-turn-on suppression circuit is constituted by a second resistor that is connected between a turn-on terminal, which outputs a turn-on voltage to the gate of the first switch, and the gate of the first switch.

6. The power supply circuit according to claim 5, wherein a resistance value of the second resistor is 47Ω or more.

7. The power supply circuit according to claim 1, wherein the false-turn-on suppression circuit is constituted by a third resistor that is connected between a turn-off terminal, which outputs a turn-off voltage to the gate of the first switch, and the gate of the first switch.

8. The power supply circuit according to claim 7, wherein a resistance value of the third resistor is 47Ω or more.
